(19) United States
(12) Patent Application Publication
(10) Pub. No.: US 2020/0394055 A1
(43) Pub. Date: Dec. 17, 2020

(54) SYSTEM AND METHOD FOR PROVIDING A CONFIGURABLE USER INTERFACE USING A SELF-DESCRIBING DATA SYSTEM

(71) Applicant: ARAS CORPORATION, Andover, MA (US)

(72) Inventors: Andrey Knourenko, Wayland, MA (US); Sean Coleman, Walpole, MA (US); Anton SHCHEKOTA, Minsk (BY); Valentsin SHAPAVALAU, Minsk (BY)

(73) Assignee: ARAS CORPORATION, Andover, MA (US)

(21) Appl. No.: 16/860,817

(22) Filed: Apr. 28, 2020

Related U.S. Application Data
(60) Provisional application No. 62/860,657, filed on Jun. 12, 2019.

(51) Int. Cl. G06F 9/451; G06F 8/38; G06F 9/54

(52) U.S. Cl. CPC G06F 9/451; G06F 9/546; G06F 8/38

(57) ABSTRACT

A method for configuring a layout of a user interface for clients may include receiving, from a first client, a first message comprising a modification to a user interface element at a location of the user interface, and a property of the user interface element. The method may also include modifying, based on the first message, an item within a self-describing data system that defines an overall layout of the user interface. The item represents the user interface element. The method may include receiving a request to view the user interface, determining metadata that defines a tailored layout of the user interface including the user interface element for the first client using the self-describing data system based on the property, and providing a second message comprising the metadata to the first client to render the tailored layout including the user interface element on a display.

### CROSS-REFERENCE TO RELATED APPLICATIONS

This application claims priority to and the benefit of U.S. Provisional Application Patent Ser. No. 62/860,657 filed Jun. 12, 2019, the entire disclosure of which is hereby incorporated by reference.

### TECHNICAL FIELD

This disclosure relates generally to user interfaces. More specifically, this disclosure relates to a system and method for a configurable user interface using a self-describing data system.

### BACKGROUND

User interfaces include numerous user interface elements or controls that provide different functionality. For example, a button may be a user interface element that, when selected (e.g., clicked), causes an operation to be performed (e.g., sends a search request to a server, etc.). To that end the user interface may provide a front end for an application that accesses one or more data systems associated with the application. Various entities may have differing requirements for functionality of the application that are exposed via a user interface, and thus, may desire differing user interface elements to be included in the user interface of the application. Additionally, the functionality requirements of the user interface for the entity may change over time as the needs of the entity change.

### SUMMARY

This disclosure provides a system and method for a configurable user interface for managing a self-describing data system.

In a first embodiment, a method for configuring a layout of a user interface for a set of clients may include receiving, from a first client, a first message including a modification to a user interface element at a location of a section of the user interface, and a property of the user interface element. The method also may include modifying, based on the first message, an item within a self-describing data structure that defines an overall layout of the user interface. The item represents the user interface element. The method may also include receiving, from the first client, a request to view the user interface, and determining metadata that defines a tailored layout of the user interface including the user interface element for the first client using the self-describing data structure based on at least the property of the user interface element. The method also may include providing a second message including the metadata to the first client to render the tailored layout of the user interface including the user interface element for the first client on a display.

In a second embodiment, a tangible, non-transitory computer-readable medium storing instructions that, when executed, cause one or more processing devices to receive, from a first client, a first message including a modification to a user interface element at a location of a section of the user interface, and a property of the user interface element. The instructions also, when executed, cause the one or more processing devices to modify, based on the first message, an item within a self-describing data structure that defines an overall layout of the user interface, where the item represents the user interface element. The instructions also, when executed, cause the one or more processing devices to receive, from the first client, a request to view the user interface, and determine metadata that defines a tailored layout of the user interface including the user interface element for the first client using the self-describing data structure based on at least the property of the user interface element. The instructions also, when executed, cause the one or more processing devices to provide a second message including the metadata to the first client to render the tailored layout of the user interface including the user interface element for the first client on a display.

In one embodiment, a system includes one or more memory devices storing instructions and one or more processing devices communicatively coupled to the one or more memory devices. The one or more processing devices may execute the instructions to receive, from a first client, a first message including a modification to a user interface element at a location of a section of the user interface, and a property of the user interface element. The instructions also, when executed, cause the one or more processing devices to modify, based on the first message, an item within a self-describing data structure that defines an overall layout of the user interface, where the item represents the user interface element. The instructions also, when executed, cause the one or more processing devices to receive, from the first client, a request to view the user interface, and determine metadata that defines a tailored layout of the user interface including the user interface element for the first client using the self-describing data structure based on at least the property of the user interface element. The instructions also, when executed, cause the one or more processing devices to provide a second message including the metadata to the first client to render the tailored layout of the user interface including the user interface element for the first client on a display.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example of a tag creating an instance of an item in a self-describing data system according to various embodiments of this disclosure;

FIG. 2 illustrates, at a structural level aspects of the configuration of an item in a self-describing data system according to various embodiments of this disclosure;

FIG. 3 illustrates an example of a configuration document for an item according to certain embodiments of this disclosure;

FIG. 4 illustrates an example of a system architecture for implementing a configurable user interface using a self-describing data system according to various embodiments of this disclosure;

FIG. 5 illustrates an example of a method for configuring a layout of a user interface for set of clients according to various embodiments of this disclosure;

FIG. 6 illustrates another example of a method for configuring a layout of a user interface for the set of clients according to various embodiments of this disclosure;

FIG. 7 illustrates an example method of receiving different item types in requests for a user interface and providing different user interface elements based on the item types according to various embodiments of this disclosure;

FIG. 8 illustrates an example user interface that may be modeled according to various embodiments of this disclosure;

FIG. 9 illustrates a hierarchy of controls to model the user interface of FIG. 8 according to various embodiments of this disclosure;

FIGS. 10A-10B illustrates various messages that are returned to the controls when the server is generating the hierarchy of controls according to various embodiments of this disclosure;

FIG. 11 illustrates an example diagram of a partial data model built at runtime according to various embodiments of this disclosure;

FIG. 12 illustrates an example diagram of another partial data model according to various embodiments of this disclosure;

FIG. 13 illustrates a portion of a data model used to store a CUI definition according to various embodiments of this disclosure;

FIG. 14 illustrates a portion of a data model presented in FIG. 12 according to various embodiments of this disclosure;

FIG. 15 illustrates an example method for building a cui_WindowSection for a particular location according to various embodiments of this disclosure;

FIG. 16 illustrates an example user interface to model a table of content tree structure according to various embodiments of this disclosure;

FIG. 17 illustrates an example HTLM tag that is generated based on a portion of a CUI definition according to various embodiments of this disclosure;

FIG. 18 illustrates an example user interface for adding a button on a global scope according to various embodiments of this disclosure;

FIG. 19 illustrates an example radio button list of item types that may be added according to various embodiments of this disclosure;

FIG. 20 illustrates a new row that may appear in a Command Bar Item tab according to various embodiments of this disclosure;

FIG. 21 illustrates an example user interface for button details according to various embodiments of this disclosure;

FIG. 22 illustrates the button added to the command bar according to various embodiments of this disclosure; and

FIG. 23 illustrates an alert that is displayed based on selecting the added button according to various embodiments of this disclosure.

### DETAILED DESCRIPTION

Some aspects of the present disclosure relate to a platform that includes one or more services hosted by one or more servers. The services may be accessed by a front-end client application that executes on a client device. The terms “front-end client application” and “client application” may be used interchangeably herein. The front-end client application may provide a user interface to enable a user to interact with data stored on the one or more servers. Each client application may be individually tailored to provide user interface elements that are desired by a user of the respective application. The platform may enable an entity to model their business using a self-describing data system. The terms “self-describing data system” and “self-describing data model” may be used interchangeably herein. The platform may be flexible and enable a user or system to create objects and relationships between the objects to define any suitable behavior or workflow for a lifecycle of the entity. For example, the platform may refer to a toolkit that allows programming an enterprise application.

According to certain embodiments, the foundational element of a self-describing data system is an item, instances of which may be maintained in persistent storage in a relational database. An “item type” may refer to a class and an “item” may refer to an object of the class. According to certain embodiments, the configuration and properties of an item may be expressed in a markup language, such as extensible markup language (XML), or Aras Markup Language (AML), which, as described in greater detail herein, follows a repeating “/Item/Relationships/Item/Relationships” pattern to describe item configurations.

Data in the platform for an entity may be described using item types and items. Metadata may be stored and/or generated that describes the item types and items. A web-based client application that executes in a browser or a standalone client application that executes by itself may provide a user interface that enables transmitting a request (e.g., XML or AML message) for data associated with an entity. The one or more servers may build a hierarchical definition using the metadata that is found for the entity in the self-describing data system. The definition may describe a layout of the user interface for the application. A response (e.g., XML or AML message) may be sent by the server including the definition of the layout, and the user interface may be dynamically rendered by the client application. In some embodiments, a format of the response message may be based on the type of the computing device that made the request. That is, the platform may be client-agnostic in that any suitable type of client may benefit from the disclosed techniques. The client devices may include one or more operating systems, such as Windows®, Android®, MacOS®, iOS®, and the like. The client application that is associated with the platform may include a UI engine that interprets user interface metadata modeling definitions in order to render the client user interface and support the behavior defined by the code associated with the definition.

The configuration of the layout may be completely customizable by the entities. The servers may maintain numerous different definitions of user interfaces for different client applications. For example, a first client application may include a definition for a button in a toolbar, and a second client application may include a definition for an input box in the same toolbar. The first and second client applications may be executed concurrently to access the platform, and the toolbar in the user interface for the first application may include the button, while the toolbar in the user interface for the second application may include the input box. At runtime, the definitions (metadata) of the layouts for the different user interfaces may be determined and/or generated and dynamically rendered by each respective client application.

The disclosed embodiments may enable modeling (e.g., creating, editing, moving, deleting, etc.) each user interface element of a user interface of a client application. For example, command bars, command buttons, forms, menus, toolbars, sidebars, shortcuts, content, item windows, sliders, accordions, and the like may be modeled in a self-describing data model using the disclosed techniques. The disclosed techniques may support content of the user interface, layout of the user interface, and behavior/functionality of the user interface.

In some embodiments, user interface modules may be developed that may be applied to differing types of client applications as long as the client applications are capable of processing the hierarchical definitions in the metadata. For example, the metadata definition for a particular command bar may be rendered by differing client applications using respective UI engines to embed the command bar into the respective user interfaces of the differing client applications. To that end, the user interface modules may be customized by each client, and thus, some embodiments enable multiple different types of user interface layouts to be generated for different types of clients (e.g., web client, mobile clients, etc.). In some embodiments, the user interface modules may be added to a user interface by configuring the client application and/or by performing a drag-and-drop operation.

The self-describing data system may be used to build the hierarchical metadata definitions that are dynamically rendered by the client applications. The term “hierarchical metadata definition” and “configurable user interface (CUI) definition” may be used interchangeably herein. The items in the definition of the layout may be defined declaratively and/or dynamically. That is, certain portions of the user interface may be defined statically in metadata (declaratively) in the self-describing data system, while others may be generated dynamically by calling one or more functions and the functions return the content for these portions. For example, how many reports that can be shown may depend on particular instance of an item, and thus, the reports may be dynamically defined at runtime. The dynamic elements may be specified as being defined through a function that returns a message (e.g., XML, AML) definition that depends on runtime content. The functions may include conditions, such as if condition 1, then return one user interface element, or if condition 2, then return three user interface elements. Further, for each user interface element, an event handler may be defined for any client runtime event and the functions to perform in response to that client runtime event may be defined.

In some embodiments, each CUI definition may be associated with a particular type of client (e.g., web client, mobile client, etc.), which allows defining a different set of user interface elements (e.g., command bars, menus, toolbars, sidebars, etc.) for the different client applications. In some embodiments, the client applications may be responsible for defining the look-and-feel of the user interfaces. In some embodiments, the individual user interface elements defined in the CUI definition may be arranged next to each other in the order in which they are defined in the CUI definition. Further, as for the overall location of a menu set, toolbar, sidebar, shortcut, etc., certain standard locations may be defined in the CUI definition that are provided to the particular client application. Thus, based on knowing the location of a particular toolbar, for example, defined through the CUI definition, the client application may determine how and where to render the toolbar.

In some embodiments, the disclosed techniques enable inheriting CUI definitions from a “global level” to a “level of item type” to a “level of individual item,” which may allow building item type-specific and/or item-specific user interface elements (e.g., command bars, menus, toolbars, sidebars, shortcuts, etc.). For example, a CUI definition for “global level” may have a toolbar for “item window toolbar” location defined with two buttons “B1” and “B2,” but an administrator desires, for items of type Part, that the toolbar in the same location contains buttons “B1” and “B3”. In this instance, in the CUI definition for item type Part, the toolbar in the same “item window toolbar” location needs to remove button “B2” and add button “B3” to the toolbar. By merging the “global level” CUI definition with the CUI definition for item type Part, the server may provide a combined definition of the toolbar with buttons “B1” and “B3”. As another example, the disclosed techniques may enable deriving item type specific command bars from global level command bars with options to add, remove, and/or override behavior of all or some user interface elements (e.g., command bar items) of the global level command bar.

In addition to merging CUI definitions based on level—global, item type, or item—to form a CUI definition that is specific for a particular context, the disclosed techniques may enable defining individual elements (e.g., a particular menu item) or group of elements (e.g., toolbar section) per identity (e.g., a user or group of users (designers, administrators, etc.) and per classification (e.g., electrical, mechanical, etc.) of the context item. This may enable, even on a single level (e.g., on “global level”), to produce different CUI definitions at runtime for different users and/or context items. For example, some embodiments enable defining, in the self-describing data system, the content of a static command bar based on the context in which the command bar is shown in the user interface. Specifically, the content of the static command bar may be modified based on the identity of the logged-in user and a classification of the context item.

A CUI definition may include the user interface metadata and may not include item specific values that fill particular user interface elements. To obtain the specific values for an item, the client may send another request to the platform. In this way, the user interface metadata may be separated from the actual item's data. The client may cache the CUI definition for faster rendering when subsequently accessed.

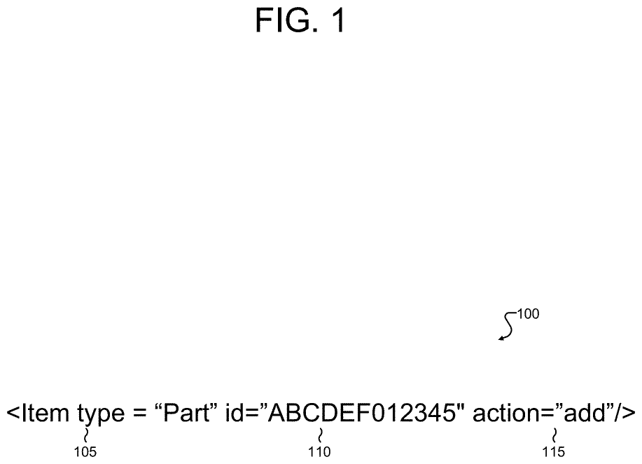

FIGS. 1 through 22, discussed below, and the various embodiments used to describe the principles of this disclosure in this patent document are by way of illustration only and should not be construed in any way to limit the scope of the disclosure.

FIG. 1 illustrates an example of an <item> tag 100 defining an instance of an item in a self-describing data system according to various embodiments of this disclosure.

Further, in the non-limiting example of FIG. 1, <item> tag 100 defines an instance of an item, which is in turn, an instance of an ItemType, which is itself an item. In this way, the instance of an item defined by <item> tag 100 belongs to a self-describing data system. Further, in some embodiments each ItemType has a relational table in the database, whose columns map to the property names of the ItemType.

According to various embodiments, the instance of the item defined by <item> tag 100 comprises three principal attributes, a type 105, an ID 110 and an action 115. It should be noted that the following three attributes are not the only attributes which can be applied to an item.

In the non-limiting example shown in FIG. 1, type 105 comprises an ItemType name for the instance of the item defined by <item> tag 100. According to certain embodiments, type 105 expresses an ItemType name for the item defined by <item> tag 100. In the non-limiting example of FIG. 1, the name of the item type is the string “Part.” According to various embodiments, the namespace for the “type” attribute is extensible and can be dynamically changed, as new names for ItemTypes become necessary. For example, in some embodiments, the item defined by <item> tag 100 may be a piece of data associated with a manufacturing process. In such cases, additional names for ItemTypes, such as “BOM” (Bill of Materials) may become necessary.

According to various embodiments, ID 110 comprises a unique identifier for the instance of an item created by <item> tag 100. In the non-limiting example of FIG. 1, ID 110 comprises the string “ABCDEF012345.” According to certain embodiments, ID 110 provides, without limitation, a primary key for the instance of the item for the purposes of providing query results.

In some embodiments, action 115 comprises a method to be applied to the instance of an item defined by <item> tag 100. In the non-limiting example of FIG. 1, the method specified by action 115 is a “add.” The instance of an item type defined by <item> tag 100 may, in some embodiments, include one or more Relationship tags, from which a query may be constructed. According to various embodiments, the methods specified by action 115 may be implemented by an API, for example, an API implementing the Aras Innovator Object Model or Item Object Model.

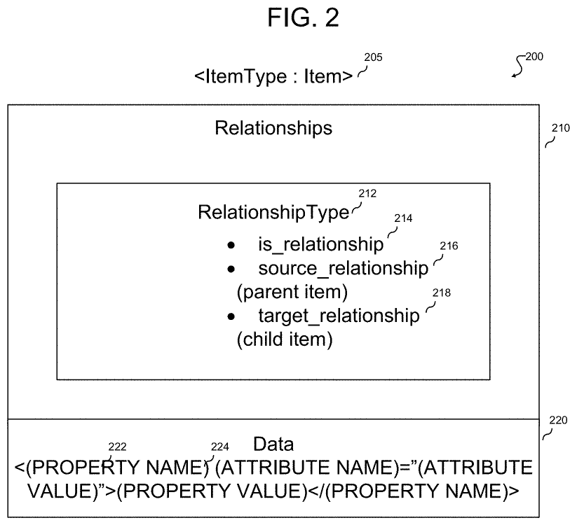

FIG. 2 illustrates, at a structural level, aspects of the configuration 200 of an item in a self-describing data system according to various embodiments of this disclosure.

Referring to the non-limiting example of FIG. 2, the item described by configuration 200 may be initially defined by an <item> tag 205, which according to various embodiments, embodies the syntax and three principal attributes of <item> tag 100 shown in FIG. 1.

According to certain embodiments, the configuration 200 of an item may be expressed as a markup language document (for example, an AML document). In some embodiments, item 200's configuration may be expressed through an “/Item/Relationships/Item/Relationships” pattern in an AML document. Further, the document expressing the configuration 200 of the item may contain data 220 (some of which are themselves, items), structure or relationships 210 (which are hierarchical items) and logic, which, as shown in the example of FIG. 1, may be expressed through an action attribute (for example, action 115 shown in FIG. 1) of each item.

In the non-limiting example of FIG. 2, relationships 210 comprise hierarchical items. According to certain embodiments, an item's relationship to one or more other items may be expressed through a RelationshipType item 212. In some embodiments, wherein the document setting forth an item's configuration is written in AML, an instance of a RelationshipType item may be defined by using the <Relationships> tag, which is a container tag holding a set of relationship items.

As shown in FIG. 2, according to certain embodiments, the set of relationship items may comprise one or more of the following three properties, an is_relationship 214, a source_relationship 216 and a target_relationship 218. A relationship in a self-describing data model may refer to a reference from a parent entity to a child entity, a parent entity to another parent entity, a child entity to another child entity, or the like. The relationships may be stored in a relationships table. The relationships may include a column for a unique identification of a row as a primary key and may store secondary keys that include the identifications of two entities having a relationship. For example, the secondary keys may refer to two identifications of a row for a part and another row for a part. The identifications referenced in the relationships table may be primary keys in a different table (e.g., parts table).

In some embodiments, when the RelationshipType 212 is created, is_relationship 214 is also created. Is_relationship 214 comprises an item, and its id is the value of the relationship_id property of RelationshipType 212. As such, is_relationship 214 operates to provide an ItemType pairing to RelationshipType 212, and to define a RelationshipType rule and an ItemType for storing the source_relationship 216 and target_relationship 218 properties of the RelationshipType item 212.

According to certain embodiments, source_relationship 216 is a property of RelationshipType 212 which comprises a link pointing to a parent item. Similarly, target_relationship 218 is a property of RelationshipType 212, which comprises a link to a child item.

As shown in the non-limiting example of FIG. 2, the configuration 200 of an item may further comprise data 220 expressed as values of properties, wherein the properties may further be specified by attributes. The XML may be in the form of “<(PROPERTY NAME) (ATTRIBUTE NAME)=”(ATTRIBUTE VALUE)“>(PROPERTY VALUE)</(PROPERTY NAME)>”.

According to certain embodiments, a property 222 defines data for an item. Examples of properties may include, for example, a cost for an item, which could be expressed in AML or XML in the form: “<cost>232.13</cost>” indicating that a particular item has a cost value of “232.13” units.

According to certain embodiments, items of data for an item may be further specified with an attribute 224, which may be analogized as metadata for the item or property, and controlling logic and methods associated with the item. For example, an attribute may define a conditional, producing an AML or XML expression of the form “<cost condition=“between”>10.00 and 50.00</cost>.” In this example, the property “cost” is further specified through the “between” attribute for which the values 10.00 and 50.00 are specified.

According to certain embodiments, the configuration 200 for an item may further include history data for the item, showing some or all of the previous configurations of the item.

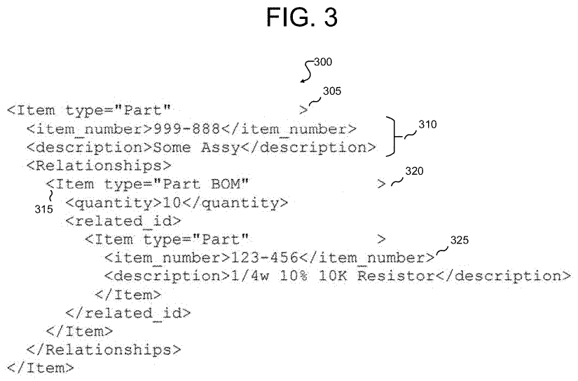

FIG. 3 illustrates an example of a configuration document 300 for an item according to certain embodiments of this disclosure. As shown in the non-limiting example of FIG. 3, an instance of an ItemType is declared through an initial <item> tag 305, which specifies that this instance of an item is of the “Part” type and is associated with an “add” method.

The properties 310 of the item are set forth, and include an “item_number” value (which, according to certain embodiments, may function as a unique identifier of the instance of the item) and a “description” value, which, in this case is “Some Assy” (an abbreviation of “some assembly.”)

Container tag 315 specifies that the item has relationships, including a first relationship 320 with item indicating an “add” method with an item of the type “Part BOM.” Item configuration 300 further specifies a “related_id” (e.g., child relationship between the “Part BOM” item and a child “part” item 325. Thus, by applying the “/Item/Relationships/Item/Relationships” pattern, a part-to-part BOM relationship may be described.

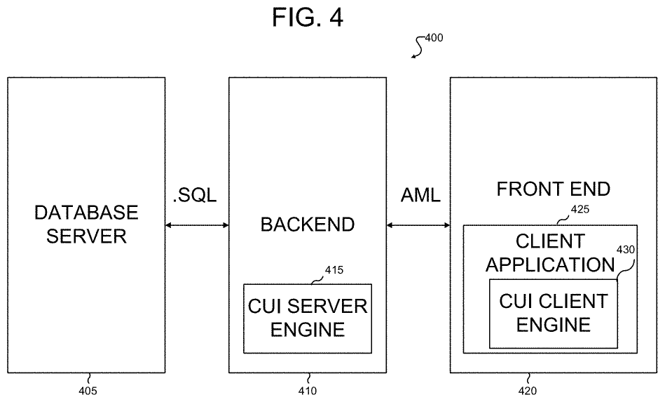

FIG. 4 illustrates an example of a system architecture 400 for implementing a configurable user interface using (CUI) using a self-describing data system according to certain embodiments of this disclosure. In the non-limiting example of FIG. 4, network architecture comprises a database server 405, a backend server 410 implementing a CUI server engine 415, and a front end 420 implementing a client application 425 including a CUI client engine 430.

According to certain embodiments, database server 405 is a server hosting data and implementing one or more database applications supporting query functionalities and user interface configuration functionalities. Database server 405 is generally platform-agnostic and may host data in a number of known database formats, including a relational database format (for example, by running an instance of .SQL server) or as a columnar database format. In the non-limiting example of FIG. 4, database server 405 is communicatively connected to backend 410. A network may be used, such as a public network (e.g., connected to the Internet via wired (Ethernet) or wireless (WiFi)), a private network (e.g., a local area network (LAN) or wide area network (WAN)), or a combination thereof to communicate between the database server 405 and the backend 410. In some embodiments, this connection is provided over a network link, and in some other embodiments, backend 410 and database server 405 may be embodied on the same piece of hardware. Skilled artisans will appreciate that embodiments according to this disclosure may be implemented on a variety of hardware platforms.

According to certain embodiments, database server 405 is configured to receive queries and/or commands expressed as statements in a domain-specific language (for example, structured query language), and return results from the database hosted on database server 405. In some embodiments, metadata that defines a layout of a user interface for the client application 430 may be stored in the database server 405 and various user interface elements of the user interface may be added, modified, deleted, etc. using the client application 425 executing on the front end 420.

According to certain embodiments, backend 410 comprises a server or other computer configured to implement a CUI server engine 415 configured to receive, from front end 420 requests expressed in the syntax of a self-describing data system (for example, AML). The requests may be query requests for retrieving a CUI definition for a user interface of the client application 425, a request to add, modify, remove one or more user interface elements of the user interface of the client application 425, and so forth. As noted elsewhere, embodiments according to this disclosure are platform-agnostic and may be practiced across a wide range of hardware configurations and development environments. In some embodiments, the CUI server engine 415 may be implemented as an ASP.NET web service. Although just one back end 410 is depicted, it should be understood that any suitable number of back ends 410 may be deployed and in communication with one another to form the platform described herein. The CUI server engine 415 may be implemented in computer instructions stored on one or more memory devices of backend 410 and executable by one or more processing devices of the backend 410.

In the non-limiting example of FIG. 4, front end 420 is communicatively connected to backend 410. A network may be used, such as a public network (e.g., connected to the Internet via wired (Ethernet) or wireless (WiFi)), a private network (e.g., a local area network (LAN) or wide area network (WAN)), or a combination thereof to communicate between the front end 420 and the backend 410. In some examples, front end 420 may be embodied on the same piece of hardware as the backend 410. According to certain embodiments, front end 420 comprises a client application 425 provided by backend 410, and provides a user interface (UI) through which queries can be input and query outputs displayed to a user. In certain embodiments, front end 420 may be constructed using modules from the HTML 5 DOJO toolkit. According to certain further embodiments, the client application 425 may include graphical user interface elements on the user interface to enable entry of modifications to other user interface elements on the user interface and to enable transmittal of a message including the modifications to the CUI server engine 415 at the backend 410.

The client application 425 and/or the CUI client engine 430 may be implemented in computer instructions stored on one or more memory devices of the front end 420 and executable by one or more processing devices of the front end 420. The CUI client engine 430 may receive a CUI definition including hierarchy metadata defining a layout of a user interface content of the user interface, layout of the user interface, and behavior of the user interface elements (controls) of the screen. The CUI client engine 420 may be configured to process and interpret the CUI definition to generate HTML, web components, or the like that represents the user interface elements on the user interface for presentation by a display screen of the front end 420. To that end, the front end 420 may be any suitable computing device, including a laptop, a desktop, a smartphone, a server, a tablet, and so forth.

Although just one front end 420 is depicted, it should be understood that any suitable number of front ends 420 may be used by various entities to access the platform. The front ends 420 may be referred to as clients herein. Each front end 420 may customize the user interface of the client applications 430 as described herein, such that the different client applications 425 have one or more similar controls and/or different controls on their respective user interfaces. The metadata for the various user interface elements may be stored in the self-describing data system in the database server 405.

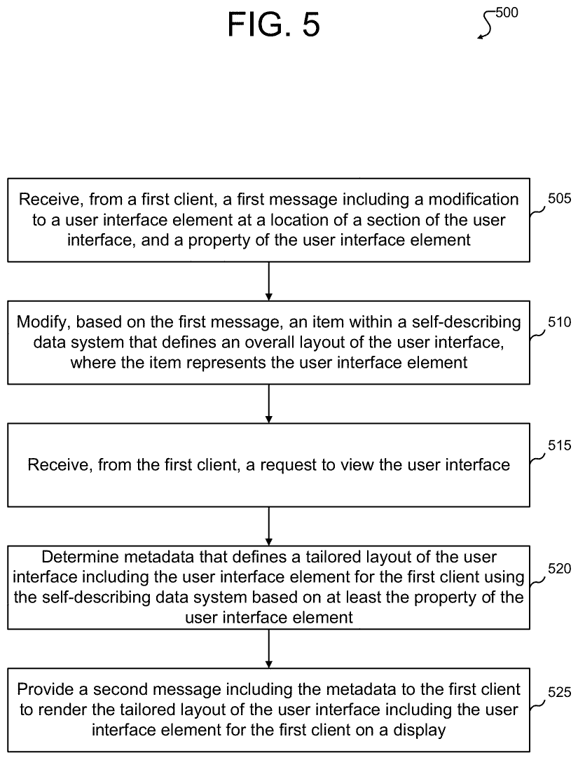

FIG. 5 illustrates an example of a method 500 for configuring a layout of a user interface for a set of clients according to various embodiments of this disclosure. One or more operations of the method 500 may be performed by the CUI server engine 415 or the CUI client engine 430.

According to the non-limiting example of FIG. 5, method 500 includes operation 505, wherein the CUI server engine 415 receives, from a first client (e.g., front end 420), a first message including a modification to a user interface element at a location of a section of the user interface, and a property of the user interface element. In some embodiments, the CUI server engine 415 may provide one or more graphical user interface elements on the user interface to enable entry of the modification to the user interface element and the property, and to enable transmittal of the first message.

In some embodiments, the property may specify including the user interface element at the location in the section globally. When the user interface element is included at the location in the section globally, each client application 425 may present that user interface element at the specified location unless further configurations are made, such as specifying the item type for the user interface element, an identity of users that may view the user interface element, and/or a classification of the user interface element. In some embodiments, the property specifies including the user interface element at the location in the section based on an item type (e.g., part) of the section. In some embodiments, the property specifies including the user interface element at the location in the section based on an identity (e.g., designer, administrator, etc.) of a user associated with the client 420 requesting the user interface. In some embodiments, the property specifies including the user interface element at the location in the section based on a classification (e.g., electrical, mechanical, software, etc.) of the item type of the section. In some embodiments, the property may specify a combination of global level, item type level, identity, and/or classification.

In some embodiments, the first message may further include an event and an event handler for the user interface element. The event may include any action performed on the client 420 that triggers the event handler to perform a specified operation to handle the event. For example, selecting a button may be a defined event and display a particular message may be the operation that handles the event.

At operation 510, the CUI server engine 415 may modify, based on the first message, an item within a self-describing data system that defines an overall layout of the user interface, where the item represents the user interface element. As discussed elsewhere in this disclosure, certain embodiments according to this disclosure utilize a self-describing data system, wherein the fundamental element of the data system is the item, which is an instance of an ItemType, which is, in turn, itself an item. Further, in certain self-describing data systems according to this disclosure, the configuration of items may be expressed through an “/Item/Relationships/Item/Relationships” pattern. The item in the self-describing data system may be modified based on the event and the event handler for the user interface element.

At operation 515, the CUI server engine 415 may receive, from the first client, a request to view the user interface. In some embodiments, the request to view the user interface may be transmitted by the client 420 concurrently with the first message including the modification, while in other instances, the request may be transmitted by the client 420 upon refreshing the user interface or logging out and logging back into the client application 425.

At operation 520, the CUI server engine 415 may determine metadata that defines a tailored layout of the user interface including the user interface element for the first client using the self-describing data system based on at least the property of the user interface element. For example, if the property of the user interface element specifies that the identity of users has to be Developers to be able to view the user interface element, then the CUI server engine 415 may determine whether the requesting user has the proper identity. If the property of the user interface element specifies that the user interface element is associated with items of type “part”, the CUI server engine 415 may determine whether the user is requesting to view items having type part or some other item type and build the CUI definition including the metadata accordingly.

At operation 525, the CUI server engine 415 may provide a second message including the metadata to the first client 420 to render the tailored layout of the user interface including the user interface element for the first client 420 on a display. The CUI client engine 430 of the client application 425 at the client 420 may interpret and process the metadata CUI definition to represent the user interface elements defined by the metadata on the user interface of the client application 425. The client 420 may render, using the CUI client engine 430, the user interface including the user interface element at the location in the section at runtime based on the metadata in the second message.

According to certain embodiments, the second message may include a markup language document (for example, a document in XML, AML or some other extensible markup language dialect). The second message may have a format type that is specific to the client 420. For example, the client 420 may be a mobile client or a web-based client and the second message may be formatted accordingly. Further, the client 420 may have a certain type of operating system, and the second message may be formatted accordingly.

In some embodiments, the CUI server engine 415 may receive, from a second client, a request to view the user interface, where the request includes a second property. The CUI server engine 415 may determine second metadata that defines a second tailored layout of the user interface, where the second tailored layout (i) excludes the user interface element for the second client using the self-describing data system based on at least the property of the user interface element (e.g., this may occur if the property specifies that the user interface element is associated with developer identities and the second client is not associated with the developer identity), (ii) includes a second user interface element for the second client that is excluded from the first tailored layout for the first client (e.g., this may occur if the second property is for items of type part and the first tailored layout was generated for items having a different type than part), or (iii) includes a third user interface element that is common in both the second tailored layout for the second client and the tailored layout for the first client (e.g., this may occur if the first client and second client are associated with the same identity and are presented with the third user interface element for that identity). Further, the CUI server engine 415 may provide a third message including the second metadata to the second client to render the second tailored layout of the user interface.

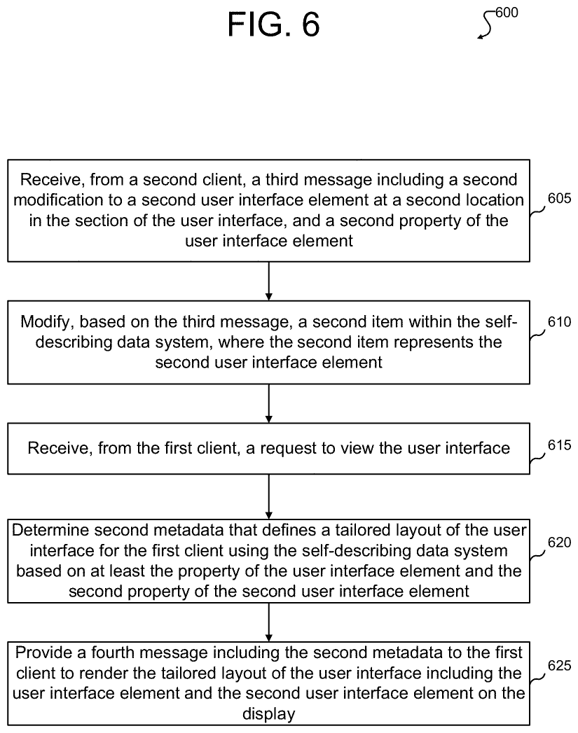

FIG. 6 illustrates another example of a method 600 for configuring a layout of a user interface for the set of clients according to various embodiments of this disclosure. One or more operations of the method 600 may be performed by the CUI server engine 415 or the CUI client engine 430. In some embodiments, the operations of the method 600 may occur subsequent to the operations in the method 500 of FIG. 5.

According to the non-limiting example of FIG. 6, method 600 includes operation 605, wherein the CUI server engine 415 receives, from a second client, a third message including a second modification to a second user interface element at a second location in the section of the user interface, and a second property of the user interface element. The second property may specify a global level, item type level, identity, and/or classification for the second user interface element.

At operation 610, the CUI server engine 415 may modify, based on the third message, a second item within the self-describing data system, where the second item represents the second user interface element. At operation 615, the CUI server engine 415 may receive, from the first client, a request to view the user interface.

At operation 620, the CUI server engine 415 may determine second metadata that defines a tailored layout of the user interface for the first client using the self-describing data system based on at least the property of the user interface element and the second property of the second user interface element. The second metadata may also be determined based on the type of the client 420.

At operation 625, the CUI server engine 415 may provide a fourth message including the second metadata to the first client to render the tailored layout of the user interface including the user interface element and the second user interface element on the display. For example, if the property and second property indicate that the user interface element and the second user interface element are defined at the global level, then they may both be included in the second metadata. In another example, if the property and second property indicate that the user interface element and the second user interface element are defined at the item type level for part, and the second client requested the user interface for item having the part type, then the user interface element and the second user interface element may be included in the second metadata.

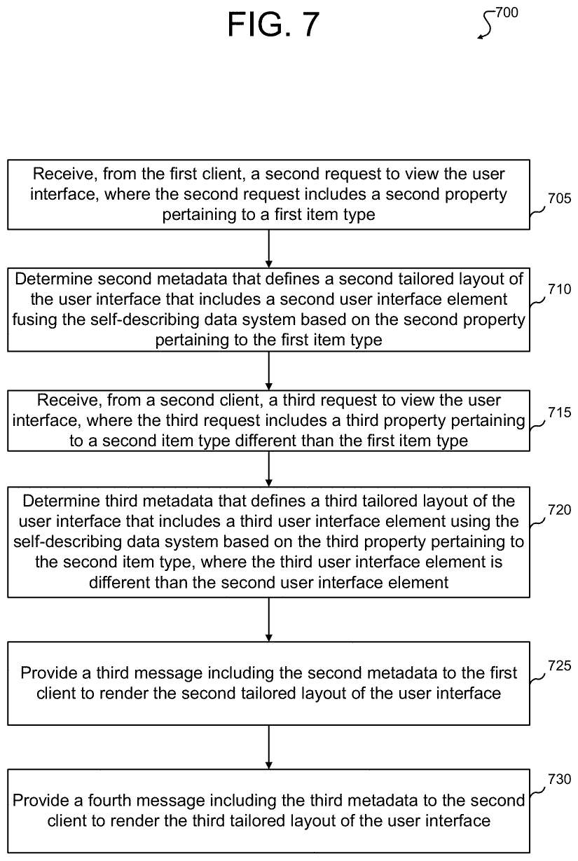

FIG. 7 illustrates an example method 700 of receiving different item types in requests for a user interface and providing different user interface elements based on the item types according to various embodiments of this disclosure. One or more operations of the method 700 may be performed by the CUI server engine 415 or the CUI client engine 430. In some embodiments, the operations of the method 700 may occur subsequent to the operations in the method 500 of FIG. 5.

According to the non-limiting example of FIG. 7, method 700 includes operation 705, wherein the CUI server engine 415 receives, from the first client, a second request to view the user interface, where the second request includes a second property pertaining to a first item type. At operation 710, the CUI server engine 415 may determine second metadata that defines a second tailored layout of the user interface that includes a second user interface element using the self-describing data system based on the second property pertaining to the first item type.

At operation 715, the CUI server engine 415 may receive, from a second client, a third request to view the user interface. The third request may include a third property pertaining to a second item type different than the first item type. At operation 720, the CUI server engine 415 may determine third metadata that defines a third tailored layout of the user interface that includes a third user interface element using the self-describing data system based on the third property pertaining to the second item type. The third user interface element may be different than the second user interface element.

At operation 725, the CUI server engine 415 may provide a third message including the second metadata to the first client to render the second tailored layout of the user interface. At operation 730, the CUI server engine 415 may provide a fourth message including the third metadata to the second client to render the third tailored layout of the user interface. As such, the second tailored layout of the user interface may present a different user interface element associated with a different item type than the third tailored layout.

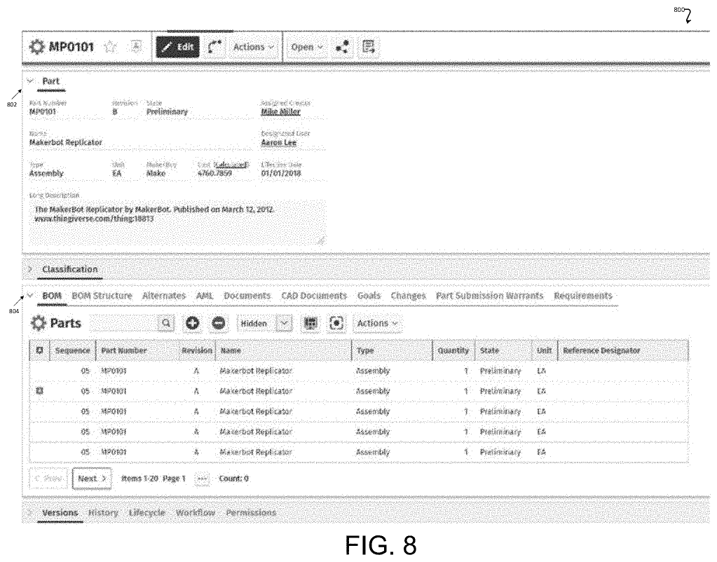

FIG. 8 illustrates an example user interface 800 that may be modeled according to various embodiments of this disclosure. The user interface 800 may be modeled/defined by metadata in a CUI definition by the CUI server engine 415. The user interface 800 may be presented by the client application 425 on the front end 420. The user interface 800 may be modeled using one or more controls described further below.

The user interface 800 includes various sections that may be modeled declaratively (e.g., having item type form in the first accordion element 802), and some sections that may be modeled dynamically (e.g., a set of relationship tabs that are shown in a second accordion element 804 varies as it depends on the set of relationship types available on the particular item type.

The user interface elements that may each be modeled as a specific type of cui_Control. Each specific cui_Control may contain zero or more other cui_Controls. The CUI client engine 430 may be configured to render the cui_Controls. In some embodiments, the cui_Controls may be placed into a specific cui_WindowSection, which has a “location”. One or more cui_WindowSections with the same “location” may be combined into a single user interface shown by the client application 425. In some embodiments, there may be a single predefined “location” for cui_WindowSections for items, which may be referred to as item_content_window. There may be other predefined “locations” for cui_WindowSections, for example a search_grid_window.

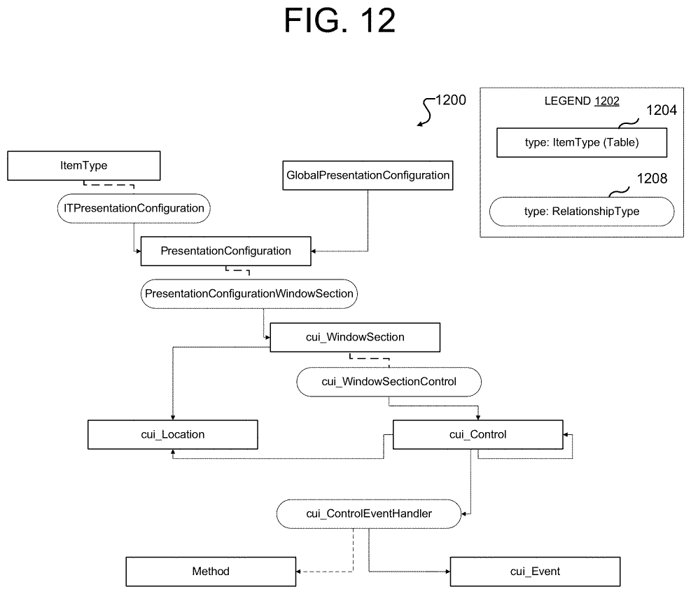

As shown in the data model in FIG. 12, cui_WindowSections are associated with a PresentationConfiguration, which is defined either on global or item type or item level. A cui_WindowSection may be of two types: declarative or dynamic. The “declarative” type may refer to the content of the cui_WindowSection is defined in the self-describing data system and contains one or more cui_Controls. The “dynamic” type may refer to the content of the cui_WindowSection (e.g., set of cui_Controls) being returned by a method associated with the “dynamic” section. If cui_WindowSections of both declarative and dynamic types are defined for the window with the same location, then the following operations may be performed: (i) the CUI server engine 415, when generating a complete CUI definition for this window, may first process each cui_WindowSections that are defined declaratively for this location, and (ii) the CUI server engine 415 may call a method that is defined on the dynamic cui_WindowSection, passing to it the CUI definition generated during operation (i). If more than one dynamic cui_WindowSections are defined for the same window location then their corresponding method may be called in the order the dynamic sections are defined on the PresentationConfiguration.

The CUI server engine 415 may generate a completed CUI definition that includes a hierarchy of cui_Controls (each control in the hierarchy has a specific type) to be rendered in the user interface by the CUI client engine 430. When the client application 425 requests to view the user interface, the following properties may be included in the requests: (i) a type of the client (e.g., web client, mobile client, etc.), (ii) “location” of the cui_WindowSection, (iii) a type of the context item, (iv) an identifier of the context item, and/or (v) additional information that may be assed to the method that builds “dynamic” cui_WindowSection.

The CUI server engine 415 may receive the requests and generate the requested CUI definition for the specified client, location, and/or context using cui_WindowSections defined on global, item type, and item levels. The CUI server engine 415 may transmit the generated CUI definition using any suitable format (e.g., JavaScript Object Notation (JSON)) that includes a hierarchy of cui_Controls with the information that is used by the CUI client engine 430 to render the user interface. In some embodiments, the client application 425 may cache the response including the CUI definition from the CUI server engine 415 so that it may be used when the CUI definition for the same “location” and item type is desired.

The following list includes example cui_Controls that may be used in various embodiments of the disclosure:
cui_StackContainer: a container that stacks its child controls either horizontally or vertically depending on an “orientation” parameter.
cui_AccordionContainer: a container for “accordion elements”.
cui_TabContainer: a container for a set of “tab elements” that provides ability to switch between tabs.
cui_AccordionElementControl: a single “accordion element” that has certain behavior (e.g. expand/minimize) and that contains one or more controls.
cui_TabElementControl: a single “tab element” that contains one or more controls.
cui_FormControl: a control that renders a particular Form definition.
cui_RelationshipControl: a control that renders “relationship toolbar” and “relationship grid” for a particular Relationship Type.
cui_ToolbarControl: a control that represents a horizontal or vertical toolbar.
cui_MenuControls: a control that represents a menu.
cui_TreeGridViewControl: a control that renders a particular TGV definition and associated with it toolbar.
cui_HtmlPageControl: a control that renders an arbitrary HTML page.
cui_LifeCycleMapControl: a control that represents Innovator “LifeCycle (LC) Map page” and is responsible for all interactions inside the page (e.g. displaying LC Map diagram; showing details of LC state when a particular LC state is selected on the diagram; etc.).
cui_LifeCycleControl: a control that represents Innovator “LC Map diagram” that is displayed when user clicks “View LifeCycle” on a particular item.
cui_WorkflowMapControl: a control that represents Innovator “Workflow (WF) Map page” and is responsible for interactions inside the page.
cui_WorkflowProcessControl: a control that represents Innovator “WF Process page” and is responsible for interactions inside the page.
cui_ItemVersionsControls: a controls that represents Innovator “Item Revisions”, screen which is shown when user clicks “Revisions” on a particular item.
cui_ItemHistoryControl: a control that represents Innovator “Item History” screen which is shown when user clicks “History” on a particular item.
cui_ItemStructureBrowserControl: a control that represents Innovator “Structure Browser” screen which is shown when user clicks on “Structure Browser” for a particular item.
cui_ItemWhereUsedControl: a control that represents Innovator “Where Used” screen, which is shown when user clicks on “Structure Browser” for a particular item.
cui_ItemPermisssionsControl: a control that represents Innovator “Permissions” screen when user clicks on Permissions->View for a particular item.
cui_MethodEditorControl: a control that represent Innovator “Method Editor” and is responsible for all interactions inside the editor.
cui_xClassControl: a control that shows specified set of xClasses and xProperties for each xClass.

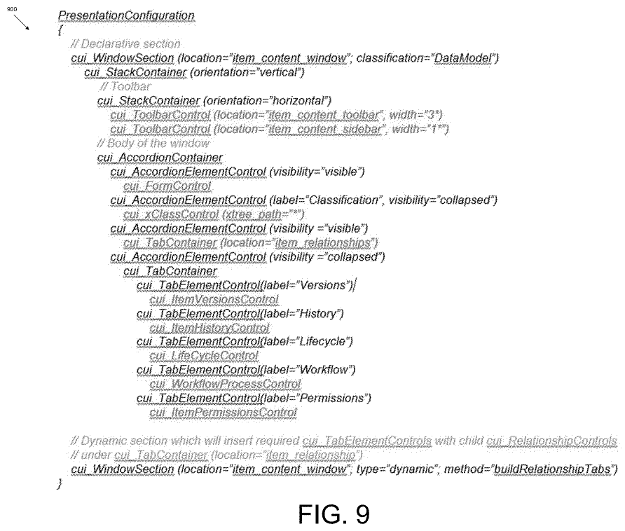

FIG. 9 illustrates a hierarchy 900 of some of the controls listed above that may be used to model the user interface 800 of FIG. 8 according to various embodiments of this disclosure. The controls may be modeled at design-time and may be defined on the global PresentationConfiguration. At runtime, the CUI server engine 415 may use the hierarchy 900 created at design-time and a parameter/property (e.g., location, item type, item, etc.) to build a complete hierarchy of controls for a specified context that may be used by the CUI client engine 430 to render the user interface.

The following controls are processed by the CUI server engine 415 at runtime to return context specific information along with each control: cui_ToolbarControl (location=“item_content_toolbar”, width=“3*”), cui_ToolbarControl (location=“item_content_toolbar”, width=“1*”), cui_FormControl, cui_xClassCoontrol (xtree_path=“*”), cui_TabContainer (location=“item_relationships”), cui_ItemVersionsControl, cui_ItemHistoryControl, cui_LifeCycleControl, cui_WorkflowProcessControl, and cui_ItemPermissionsControl.

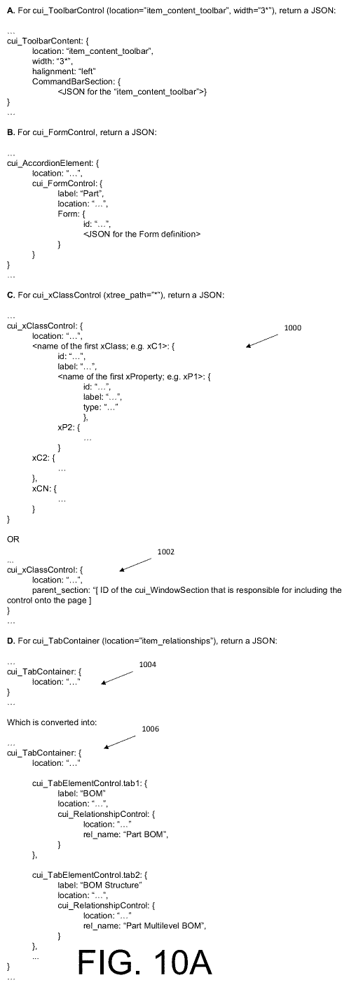

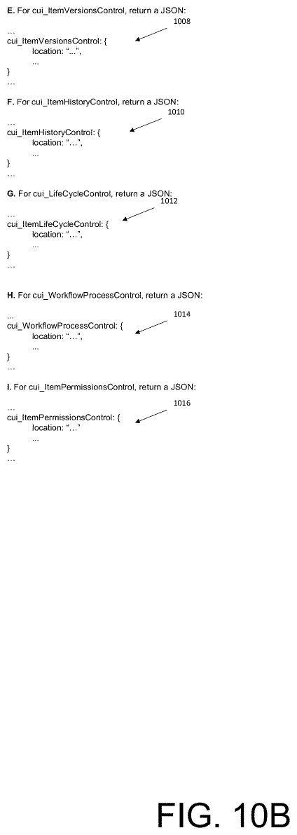

Each of these controls will now be discussed with reference to FIGS. 10A-10B, which illustrates various messages that are returned to the controls when the server is generating the hierarchy of controls according to various embodiments of this disclosure.

Beginning with FIG. 10A, and more particularly at control A, for cui_ToolbarControl (location=“item_content_toolbar”, width=“3*”), the CUI server engine 415 may identify a CUI CommandBarSection defined for the same “client type” and for the same “location” on global, item type, and item levels and build the resulting CommandBarSection. The depicted JSON may be returned for the control to the CUI client engine 430. In some embodiments the message returned by the CUI server engine 425 may be AML or XML or any suitable notation/markup language. In some embodiments, a layout attribute may be included in the JSON (e.g., width, height, vertical alignment (valignment), horizontal alignment (halignment), etc.). If the layout attribute is not defined in the message, the CUI client engine 430 may use certain default rules for the layout of the control. The default rules may specify automatically using certain widths, heights, valignments, halignments, etc. based on the type of control and/or location.

At control B, for cui_FormControl, the CUI server engine 415 may identify a Form item for the specified Item and return a JSON similar to the one depicted. In some embodiments, just the ID of the Form may be returned because, in some instances, the client application 425 may cache the Form and can use the ID to obtain the Form. In another instance, the ID may be used to obtain the Form from the backend 410 in a separate request.

At control C, for cui_xClassControl (xtree_path=“*”), the CUI server engine 415 may, based on the xtree_path specified, identify the xClasses that the context item is classified with and the xProperties. The CUI server engine 415 may return a JSON 1000 similar to the one depicted.

In some instances, if the visibility of a parent cui_Control (e.g., in this case cui_AccordionElementControl) is set to collapsed or hidden, the CUI server engine 415 may postpone returning the CUI definition of the control to enhance peformance. Instead, the information may be returned based on another request from the client application 425 (e.g., when the user expands the accordion element on the user interface). In such an instance, the reduced JSON 1002 may be returned with the initial CUI definition.

In some embodiments, when the ID of the cui_WindowSection is included in the response JSON, the CUI definition associated with that control may be obtained in a separate request to the backend 410. When such a request is made to the backend 410, the CUI server engine 415 may determine if the parent cui_WindowSection has a “dynamic” or “declarative” type. If the type is “declarative”, then the CUI server engine 415 may use context information (e.g., item and its item type) to build the CUI definition of the requested control (e.g., in the case of cui_xClassControl it may include information about xClasses and xProperties that should be displayed in the control). If the type is “dynamic”, then the CUI server engine 415 may call the building method set on the “dynamic” cui_WindowSection, and pass to it the information sent by the client and a null as a reference to the CUI definition structure previously formed by cui_WindowSections with the identical location. The method may return the CUI definition for the requested control.

At control D, for cui_TabContainer (location=“item_relationships”), the CUI server engine 415, when processing the design-time CUI definition, may insert the depicted JSON 1004. In some embodiments, the content of the cui_TabContainer may be filled by the dynamic cui_WindowSection. For example, a method, buildRelationshipTabs, that is defined in the section may be used. The buildRelationshipTabs may accept the context item and its item type as parameters. Because each declarative section is processed prior to calling the method and the method accepts the result of this processing as a parameter, the method may find, in the parameter, the JSON 1004 for the cui_TabContainer using its location and convert it into JSON 1006.

Turning to FIG. 10B now, at control E, for cui_ItemVersionsControl, the CUI server engine 415 may return a JSON 1008 similar to as depicted. At control F, for cui_ItemHistoryControl, the CUI server engine 415 may return a JSON 1010 similar to as depicted. At control G, for cui_LifeCycleControl, the CUI server engine 415 may return a JSON 1012 similar to as depicted. At control H, for cui_WorkflowProcessControl, the CUI server engine 415 may return a JSON 1014 similar to as depicted. At control I, for cui_ItemPermissionsControl, the CUI server engine 415 may return a JSON 1016 similar to as depicted. At control I, for cui_ItemPermissionsControl, the CUI server engine 415 may return a JSON 1016 similar to as depicted.

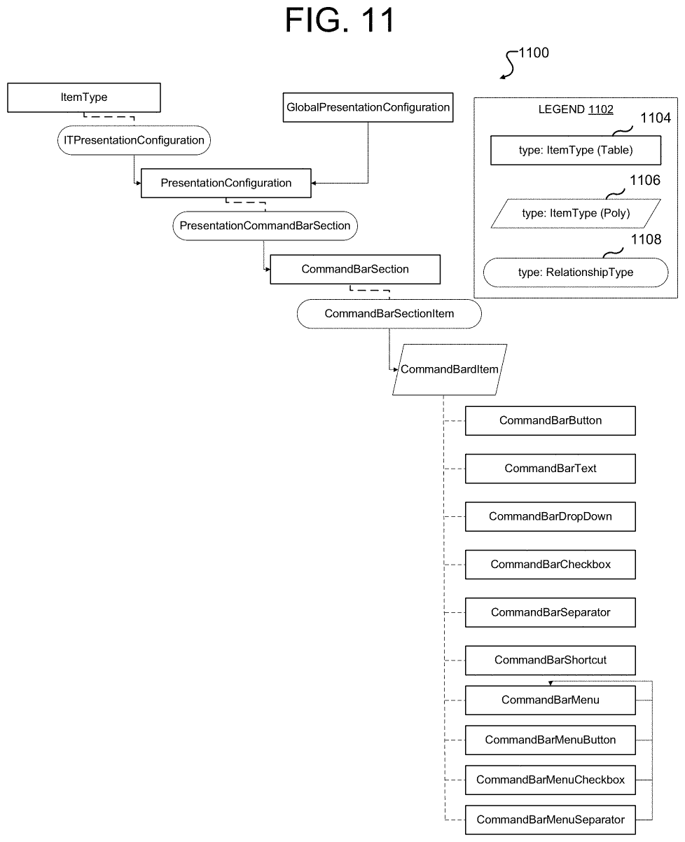

FIG. 11 illustrates an example diagram of a partial data model 1100 built at runtime according to various embodiments of this disclosure. Note that, in this particular example, partial data model 1100 comprises a hierarchical, tree like structure. As depicted, a legend 1102 indicates that each rectangle 1104 has a type “ItemType” and is associated with a table, each rhombus 1106 has a type “ItemType and is polymorphic, each rounded rectangle 1108 has a type “RelationshipType”.

At the root node, ItemType is depicted. PresentationConfiguration depends from ItemType and has a relationship type of ITPresentationConfiguration with ItemType. It should be noted that ITPresentationConfiguration may be defined per client type. Also, a GlobalPresentationConfiguration may be associated with the PresentationConfiguration. The GlobalPresentationConfiguration may be defined per client type, per location (e.g., MainWindow, ItemWindow, etc.). An item type for CommandBarSection may be related to PresentationConfiguration based on a relationship type of PresentationCommandBarSection.

As depicted, each CommandBarItem is associated with a CommandBarSection via a relationship type of CommandBarSectionItem. Each CommandBarMenuXXX items that form a hierarchy between themselves also are associated with a CommandBarSection. The relationship CommandBarSectionItem is not only responsible for associating a particular instance of CommandBarItem with a particular CommandBarSection, but it may also hold information that is used to build context specific CommandBarSection. For example, CommandBarSectionItem relationship may define: (i) context related information like identity of the current user and classification of the context item that is used to determine if the related CommandBarItem should be considered during the process of building the CommandBarSection, (ii) an action applied to the related CommandBarItem when building the CommandBarSection (possible values of the action may include add, remove, replace, clear all), and/or (iii) an order in which the CommandBarItem will be inserted into the CommandBarSection. The same process may be applied when building a set of menus that have hierarchical structure and each CommandBarMenuXXX item, besides being associated with the parent CommandBarSection, may have a reference to the parent CommandBarMenu.

FIG. 12 illustrates an example diagram of another partial data model 1200 according to various embodiments of this disclosure. Note that, in this particular example, partial data model 1100 comprises a hierarchical, tree like structure. As depicted, a legend 1202 indicates that each rectangle 1204 has a type “ItemType” and is associated with a table, and each rounded rectangle 1208 has a type “RelationshipType”.

As depicted, the partial data model 1200 includes the same item types and relationship types starting at PresentationConfiguration and above as the partial data model 1100 of FIG. 11. The partial data models 1100 and 1200 may be used in conjunction with one another or independently. Below are example definitions of the aspects of the partial data model 1200:

cui_Control (IT)
versioned=0
TOC Access: NULL
Can Add: Administrators
Permissions: Default Access
   control_type (cui_ControlTypes: List; is_required=1)—defines type of the control (e.g. cui_StackContainer).
   parent_control (cui_Control)—reference to the parent control. Can be null if the control is top level control in the hierarchy.
   location (cui_Location)—reference to the location item; can be null. The property can be used, at least, for two purposes: a) through referencing a location, the control can be associated with other items that reference the same location item (e.g. CommandBarSection that represents a context menu or shortcuts available on the control); b) the location can serve as identifier so that it can be found by a method code of a dynamic cui_WindowSection. If the property is not defined, the control implicitly inherits its location from the parent control or parent cui_WindowSection. It is suggested that server always returns explicit or implicit location of the cui_Control to the client.
   label (MLString:64; is_required=0)—optional user-visible label.
   additional_data (Text, is_required=0)—static JSON with properties mapped to control, as well as any other additional information that can be understood and interpreted by the client application 425.

cui_WindowSection (ItemType)
versioned=0
TOC Access: NULL
Can Add: Administrators
Permissions: Default Access
   location (cui_Location; is_required=1; keyed_name_order: 0)—defines the “location” of the section in the client UI.
   classification (Method|DataModel, is_required:1)—identifies how content of section is calculated: dynamically via Method execution or declaratively based on data structure.
   builder_method (Item:Method, class_path:Method)—class specific property, is used only in case the classification equal to Method. In this case property cannot be null.
   description (string:256)

cui_PresentationConfigurationWindowSection (RelationshipType)
is_relationship=1; 0 . . . oo
use_src_access=1
   source_id (Item: PresentationConfiguration)—source PresentationConfiguration.
   role (Item: Identity, is_required:1, label:For Identity)—defines Identity which the current user must be a member of in order to view particular cui_WindowSection. By default, it is set to World Identity value.
   item_classification (String:512, label:For Classification)—the property must contain classification path, which restricts usage of particular cui_WindowSection only for items of such classification. Empty value means that the cui_WindowSection is used for items of any classification.
   related_id (Item:cui_WindowSection)—reference to the instance of cui_WindowSection.

cui_WindowSectionControl (RelationshipType)
is_relationship=1; 0 . . . oo
use_src_access=1
   source_id (Item: cui_WindowSection)—source window section.
   role (Item: Identity, is_required:1, label:For Identity)—defines Identity which the current user must be a member of in order to view particular cui_Control. By default, it is set to World Identity value.
   item_classification (String:512, label:For Classification)—the property contains classification path, which restricts usage of particular cui_Controls only for items of such classification. Empty value means that the cui_Control is used for items of any classification.
   related_id (Item: cui_Control)—reference to the instance of cui_Control.

cui_Location (ItemType)
This is a “location” item that can be referenced from other CUI items like cui_WindowSection; cui_Control; and even CommandBarSection. The amount of locations is flexible and can change even for the same client application 425 over time.
versioned=0
TOC Access: NULL
Can Add: Administrators
Permissions: Default Access
   name (String:64, is_required:1, unique: 1, keyed_name_order: 0)—uniquely identifies the “location” of either cui_WindowSection or cui_Control.
   description (String:256)

cui_Event (ItemType)
Items of this type define events that can be fired by controls and to which other controls can subscribe.
versioned=0
TOC Access: NULL
Can Add: Administrators
Permissions: Default Access
   name (String:64, is_required:1, unique: 1, keyed_name_order: 0)—uniquely identifies the type of the event. Note that when event is fired by a control, the client code specifies the type and location of the control on which the event is fired. This allows to use the same event on multiple controls—e.g. event with name=“init” can be reused with multiple controls (e.g., controls may have an event handler set for the event). At the same time, in some cases a client administrator might want to use a very specific event (e.g. “cell focus in grid” vs. generic “focus” event) in order to avoid subscribing to a large number of events (e.g. in case control A fires event “focus” but control B would like to react to “focus” event from a grid cells only, it's required that the event handler on control B, which will be triggered every time “focus” event is fired by any control inside its cui_WindowSection, filter out events that are originated not from the grid). In this case, events may be given names like grid.cell.focus which can allow to subscribe to this particular event only.
   description (String:256)—optional description that describes the event; its purpose; etc.

cui_ControlEventHandler (RelationshipType)
is_relationship=1; 0 . . . oo
use_src_access=1
   source_id (cui_Control)—defines the control on which the event handler will be invoked.
   related_id (Method)—defines the method that will be invoked.
   control_event (cui_Event)—type of event for which the handler must be invoked.
   fired_from_location (cui_Location)—defined the location of the control that fires the event. This means that the “dispatcher” of the parent cui_WindowSection, that calls event handlers of subscribed child controls, will only call the method, which is set on related_id of the relationship, if the control that fired the event has location equal to the location set on event location. If the property is not specified then the event handler may be called any time the event is fired independently of the location of the control that fired the event.

In some embodiments, each control may include its own set of unique control-specific types of events. For instance, current grid implementation in Aras Innovator web client has events like: “cell focus”, “cell edit”, “drag column”, etc. Because in the disclosed embodiments each client application 425 may have its own set of controls, the set of events that can be fired in each client application can be very different from events in another client application 425. Thus, any desired custom event may be created to which other controls should be capable to subscribe. To support this, and as described above, the data model may include ItemType cui_Event instances of which can created by administrator.

Events may be fired by the client application 425 (i.e. by the code that constitutes the client application) from practically anywhere (it depends on how the code is written, etc.) in the code. Further, the same event can be fired from more than one place in the code—e.g. the same event can be fired when user clicked a button, pressed a short-cut key combination or dragged an icon in the user interface to a specific location. At the same time, a set of events that a specific client application can fire are correlated with the types of events defined in the metadata. Thus, any time administrator would like to add a new type of event that some of controls can fire and other controls should be able to subscribe to, a new instance of cui_Event in the database may be created.

Firing events may be performed by the code implementing the client application 425, and broadcasting the fired events to controls that subscribed to the fired events may also be performed by the code implementing the client application 425. The client application 425 may have a mechanism that catches fired events and forwards them to subscribers of the event. A standard “event catcher” may be implemented on the level of cui_WindowSections with identical location—i.e. all events fired by controls inside cui_WindowSections with the same location will bubble up, using Hyper Text Markup Language (HTML)/Document Object Model (DOM) bubbling mechanism, to the DOM element that defines the “window section” (e.g. <div> or <iframe>). This DOM element has an event handler that is triggered for all events that can possibly be fired by controls inside the window section and that will play the role of “dispatcher”. The dispatcher checks which controls inside the window section subscribed to this particular event, and from this particular location, and invokes their corresponding event handlers passing to them certain information. Note that client code that fires the event on a control may pass the type of the control and the location of the control (e.g., ctype=“cui_AccordionElementControl”; location=“item_content_window”) that enables subscribers to identify which controls fired the event in case multiple controls of the same type exist inside the “window section”.

The metadata may define the kinds of events to which the control subscribes and the code/method to call to handle the events. Thus, each control may have a set of event handlers associated with it and the kind of event for which the event handler is invoked. The cui Event items may be used for this purpose. Having the ability to declaratively define, at design-time, the events to which each control will subscribe, and implement event handlers for corresponding events, provides users with customization points that can be used to alter behavior of controls supported by a specific client application 425.

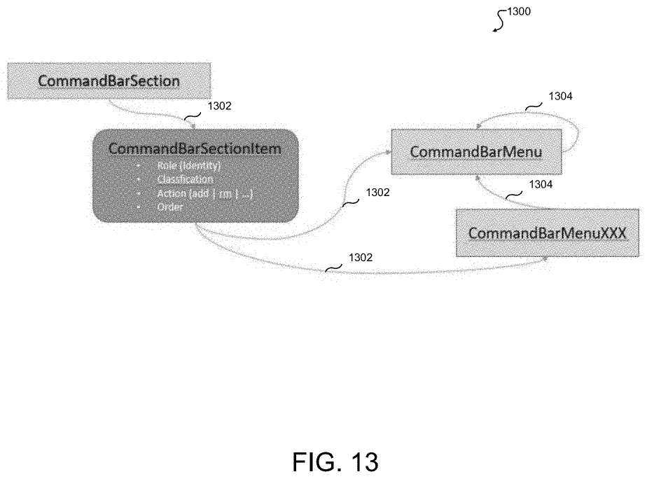

FIG. 13 illustrates a portion 1300 of a data model used to store a CUI definition in the system according to various embodiments of this disclosure. In some embodiments, CommandBarMenuXXX may refer to one of the following: CommandBarMenuButton, CommandBarMenuCheckbox, CommandBarMenuSeparator (see FIG. 11 for additional details pertaining to the data model). As depicted, arrows 1302 define relationships that determine, based on role (identity) and classification, if the particular CommandBarMenu or CommandBarMenuXXX item should be considered during the building process of the CommandBarSection. If so, then the CommandBarMenuXXX is applied to the hierarchy, defined using arrows 1304 referencing the parent CommandBarMenu, using CommandBarSectionItem.action and the CommandBarSectionItem.order.

The disclosed technique separates hierarchy of controls (in this case CommandBarMenuXXX items) from the information that allows, at runtime, determining whether a particular control needs to be considered to be applied to the hierarchy. Since each CommandBarItem is directly associated with a CommandBarSection, this may support (i) a mechanism of building context specific sections that entail merging CommandBarSections with the same location from “global scope”, “item type scope”, and “item scope”, and/or (ii) setting up particular parts of the hierarchy that are shown for a particular identity or for a particular classification of the context item.

In some embodiments, the cui_Controls form a hierarchy and cui_Control hierarchies defined on global, item type, and item level and associated with cui_WindowSections with the same location may be merged. To merge, each cui_Control may be directly associated with cui_WindowSection. This association (relationship type) may include the following information: (i) identity of the current user and classification of the context item that enables determining at runtime if the control should be considered during the process of building the CUI definition for a particular cui_WindowSection, (ii) action (add, remove, modify, etc.) that is applied to the respective control when the control is used in the building process of the cui_WindowSection, and/or (iii) an order in which the cui_Control is inserted into its parent's hierarchy.

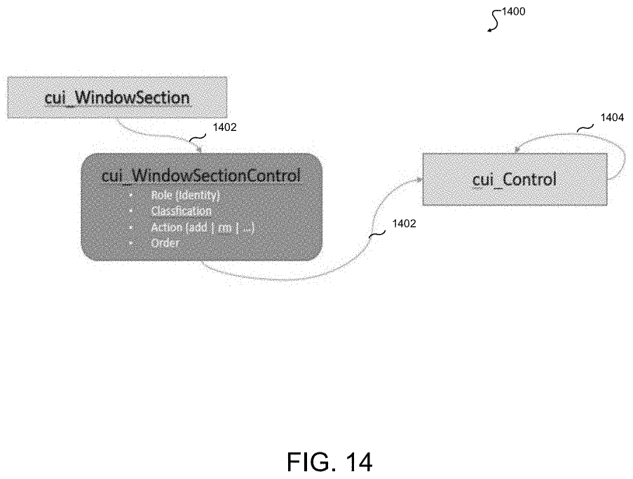

FIG. 14 illustrates a portion 1400 of a data model presented in FIG. 12f according to various embodiments of this disclosure. As depicted, arrows 1402 define relationships that determine, based on role (identity) and classification, if the particular cui_Control item should be considered during the building process of the cui_WindowSection. If so, then the cui_Control is applied to the hierarchy, defined using arrows 1404.

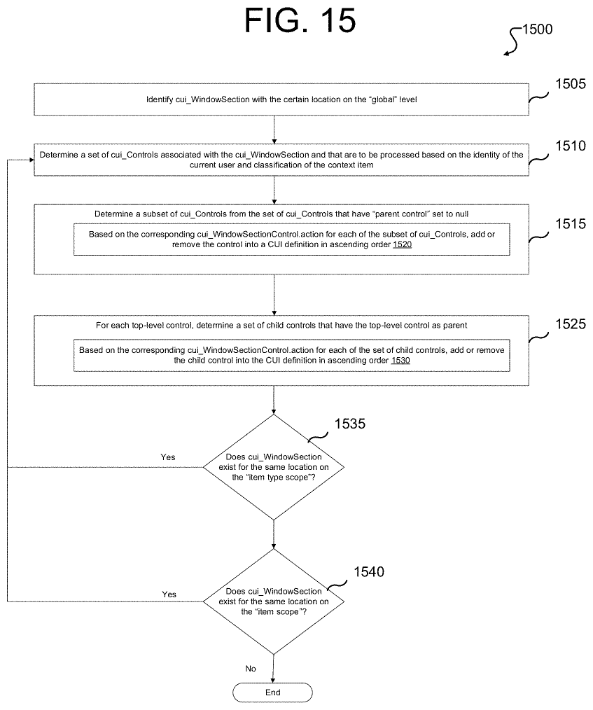

FIG. 15 illustrates an example method 1500 for building a cui_WindowSection for a particular location according to various embodiments of this disclosure. One or more of the operations of the method 1500 may be performed by the CUI server engine 415 or the CUI client engine 430. The method 1500 may be implemented as a state machine.

At operation 1505, the CUI server engine 415 may identify a cui_WindowSection with a certain location on the global level. At operation 1510, the CUI server engine 415 may determine a set of cui_Controls associated with the cui_WindowSection and that are to be processed based on the identity of the current user and classification of the context item. At operation 1515, the CUI server engine 415 may determine a subset of cui_Controls from the set of cui_Controls that have “parent control” set to null (these are the top-level controls in the cui_WindowSection. At operation 1520, based on the corresponding cui_WindowSectionControl.action, add or remove the control into the resulting CUI definition in ascending order.

At operation 1525, for each top-level control, determine a set of child controls that have the top-level control as a parent. At operation 1530, based on the corresponding cui_WindowSectionControl.action for each of the set of child controls, add or remove the child control in the CUI definition in ascending order. Operations 1525 and 1530 may be repeated recursively for children of controls added in the operation 1515 and 1520.

At operation 1535, a determination may be made whether the cui_WindowSection exist for the same location on the “item type scope” (e.g., on PresentationConfiguration associated with the context item's ItemType). If so, the method 1500 may proceed to operation 1510 to continue processing for the cui_WindowSection. If not, the method 1500 may include performing operation 1540 by determining whether the cui_WindowSection exist for the same location on the “item scope”. If so, the method 1500 may proceed to operation 1510 to continue processing for the cui_WindowSection.

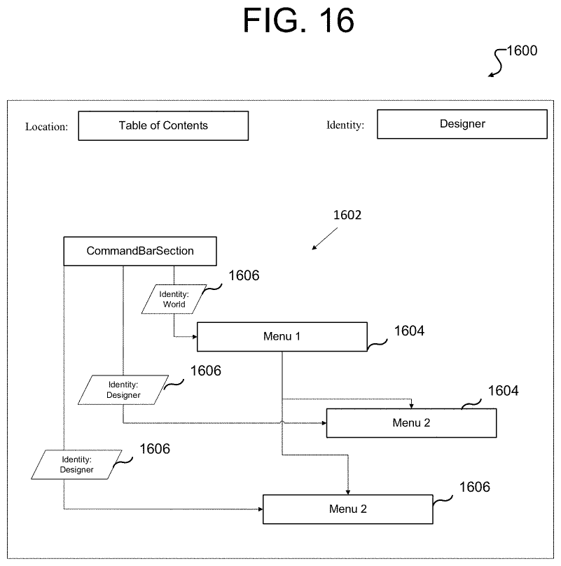

FIG. 16 illustrates an example user interface 1600 that allows administrator to model a table of content tree structure for the client application according to various embodiments of this disclosure. There may be user interface elements associated with certain identities (e.g., administrator, designer, etc.) that should appear in table of contents for those particular identities and not be viewable in a table of contents for other identities. Accordingly, the disclosed embodiments may display an existing table of contents 1602 for a particular identity (e.g., Designer) with ability to expand/collapse each menu 1604 or all of them at once. The identity may be selected as either a specific identity or a user may select “All”. The user interface 1600 may present a list of each identity that are currently set on CommandBarSectionitem relationships of the CommandBarSection (location=Table of Contents (TOC)), as well as enable a user to enter an identity to search. When an identity is selected, the user interface 1600 may filter out the TOC structure per this identity (e.g., present the TOC at it would be seen by a user who belongs to the specified identity).

Further, some menus, such as Menu 1 having an identity World, may appear when the user has selected identity for Designer. Since World may indicate a global level definition, which may specify that the item appear regardless of other items appear, Menu 1 may be included in the TOC 1602. To understand the identity that is set on the relationship CommandBarSectionitem that connects CommandBarSection(location=TOC) to Menu 1, an indicator 1606 is used to identify that the identity for Menu 1 is World. The indicators 1606 for Menu 2 and Menu 3 indicate the identity is Designer. Accordingly, using such indicators 1606 may provide clarity to why certain menus are included in the TOC 1600.

In embodiments where “All” is selected for the identities, the user interface 1600 may present a TOC tree that represents the union of all TOC trees for all identities or, which is the same, the TOC structure as it would be seen by a “super user” identity. In some embodiments, building the table of contents 1602 may be interactive. For example, an ability to drag-and-drop tree nodes (including non-leaf nodes) to other places in the hierarchy may be enabled. The order of nodes at runtime may be the same as order of nodes created at design-time. Note that when node N1 is moved under a new parent—e.g. node P1—a determination may be made that the identity that is set on the CommandBarSectionitem to the node N1 is a member of the identity set on the CommandBarSectionitem of its parent node P1. If it is not a member, a warning may be displayed that not all members of the identity, that is set on the CommandBarSectionitem to the node N1, may be able to see the TOC structure the way the administrator is trying to build it.

To understand the situation better, consider the following example: CommandBarSectionitem to node N1 has identity World and CommandBarSectionitem to node P1 has identity Designer. Right now, anyone can see node N1 in TOC tree. If node N1 is moved under new parent P1, users who are not members of the Designer identity, then N1 will not be shown in the user interface 1600 because its parent P1 cannot be seen, and, correspondingly, the users are not able to see the whole subtree under P1. If the administrator decides to ignore the warning then parts of the TOC structure that have “incorrect” identities may be displayed in a distinct color to alarm administrator that the structure has problems. This may be useful in scenarios where the identity membership was consistent when the TOC was designed but later was modified in such a way that identities set on the TOC structure are “incorrect”. In this case, when an administrator opens the user interface for modeling the TOC, the administrator may see the parts of the structure that are not “correct” and which need changes of identities set on some CommandBarSectionItems. Further, some embodiments provide an ability to change identity set on the CommandBarSectionitem to any node in TOC tree, and an ability to find and select an ItemType and drag-and-drop it into the existing TOC tree structure.

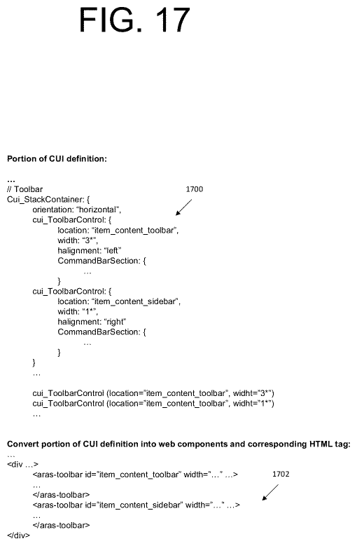

FIG. 17 illustrates an example Hyper Text Markup Language (HTML) 1702 that is generated based on a portion of a CUI definition 1700 according to various embodiments of this disclosure. In some embodiments, various controls disclosed herein may have a corresponding web component that may be converted into a custom HTML tag that represents the corresponding web component. In the depicted example, the CUI definition 1700 may be generated by the CUI server engine 415 and returned to the CUI client engine 430. The CUI definition returned from the backend 410 may be metadata that allows placing corresponding web components in a page document object model (DOM). The DOM represents a tree with a logical structure. Each web component may obtain context specific data (e.g., values for item properties to be shown in the Form) and present this data within the page fragment associated with the web component. The CUI client engine 430 or CUI server engine 415 may convert the CUI definition 1700 into the custom HTML tag 1702.

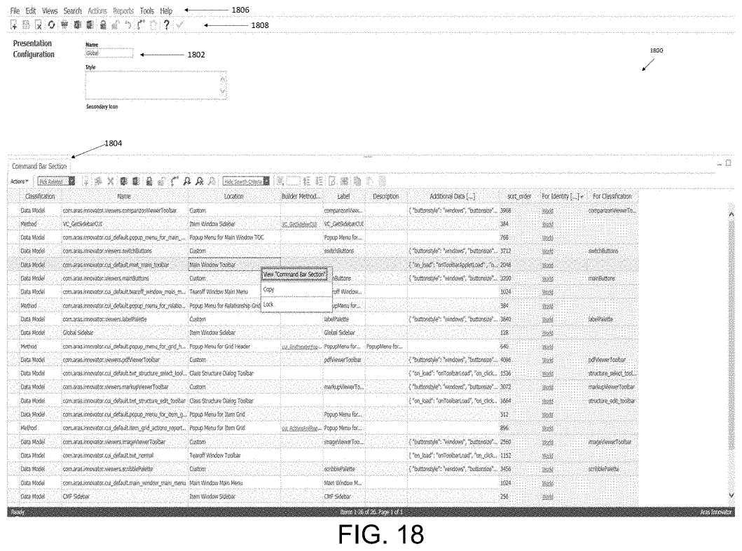

FIGS. 18-23 depict example user interfaces for adding a button a global scope for a particular client application. FIG. 18 illustrates an example user interface 1800 for adding a button on a global scope according to various embodiments of this disclosure. As discussed previously, an overall layout of the user interface 1800 may be stored as metadata in the self-describing data system. The disclosed techniques may enable modifying, adding, deleting, etc. user interface elements that are defined by the metadata, and when a request to view the user interface is received, the CUI definition including a hierarchy of controls may be generated and delivered to the client application 425 for rendering.

There may be a GlobalPresentationConfiguration including ItemTypes of CommandBarSection, which may include definitions for default user interface elements and self-defined user interface elements for various command bars (meus, toolbars, sidebars). The GlobalPresentationConfiguration may define, for each location of the user interface, what the user interface elements are, the content, and the way they behave. When a user interface element or control is defined on the global level, the user interface element applies to any item or item type specified for the user interface element. Each client application 425 may modify the user interface elements associated with a CommandBarSection by defining a type of the user interface element, a location of the user interface element, an identity associated with the user interface element, an event associated with interacting with the user interface element, and an event handler to handle the event, and so forth. These modifications may be performed on a global level, item type level, or item level. In some embodiments, item type level specific command bars may be applied on top of global level command bars.

In the depicted user interface 1800, the global presentation configuration may be selected from the table of contents. A name 1802 of “Global” may be presented in a section of the user interface 1800. A command bar section tab 1804 may be presented with data arranged in rows and columns for “Classification”, “Name”, “Location” “Builder Method”, “Label”, “Description”, “Additional Data”, “sort_order”, “For Identity”, “For Classification”. The classification may include “Data Model” or “Method”. The name may be a unique text string. The Location may specify which portion of the user interface the row is associated with. For example, Locations may include “Item Window Sidebar”, “Popup Menu for Main Window TOC”, “Main Menu”, “Main Toolbar” (shown as 1806), “Main Window Toolbar” (shown as 1808), “Items Grid Toolbar”, “Tearoff Window Main Menu”, and so forth. The builder method may specify the method that is called by CUI server engine 415 when building the “dynamic” parts of the CUI definition. The Label may provide a brief label for the user interface element. Additional data may allow any suitable data to be associated with the user interface element, such as layout data. The sort order may specify in which order the user interface element is to be added to a sequence of a command bar. The For Identity may specify which identities can interact with the user interface element. The For Classification may specify which classifications can interact with the user interface element. This information may be added to the self-describing data system as metadata for the user interface element.

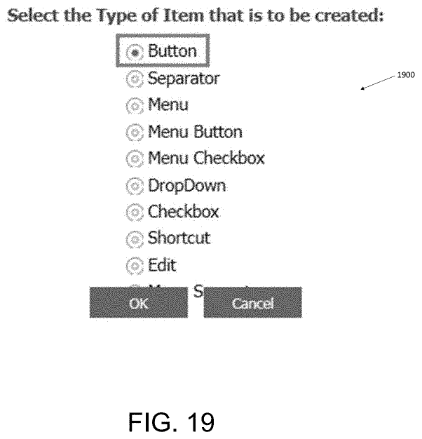

To add a button to the Main Window Toolbar, administrator may use an input peripheral (mouse, keyboard, stylus, touchscreen) to select item with Location: Main Window Toolbar, and select “View ‘Command Bar Section’”. Further, the user may select to create a user interface element related to the Main Window Toolbar in a Command Bar Item tab, and that it is a new relationship. A radio button list 1900 of item types may appear, as depicted in FIG. 19. A user may select Button from the radio button list 1900 and select the OK button.

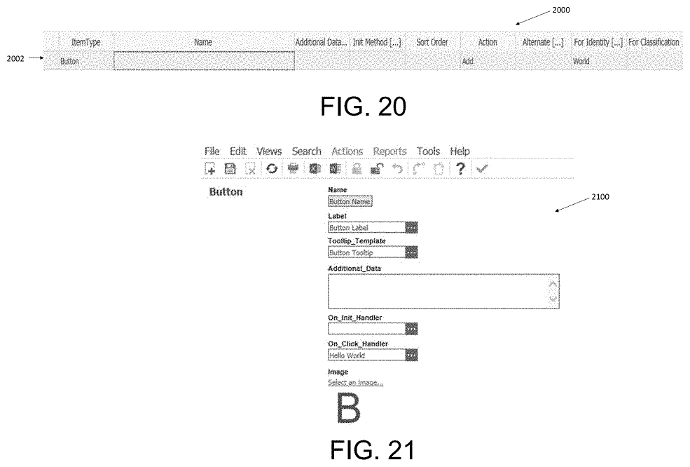

FIG. 20 illustrates a new row 2000 that may appear in a Command Bar Item tab according to various embodiments of this disclosure. An “ItemType” may be populated with Button as a result of the selection in FIG. 19. Further, to add the button, the Action may be set to “Add” and to set it at the global level, the For Identity may be set to “World”. In some embodiments, other actions may be selected, such as “remove” to remove the desired user interface element (command bar item), “replace” to replace the user interface element, or “clear all” to remove all user interface elements associated with the command bar. Additionally, a suitable Identity may be selected to configure which users are allowed to view, interact, or access the button. A user may select to “View Command Bar Item”, which prompts an example user interface 2100 depicted in FIG. 21.

The user interface 2100 may present graphical user interface elements to input button details. For example, options for “Name”, “Label” (“Button Label” has been input), “Tooltip_Template” (“Button Tootip” has been input), “Additional Data”, “On_Init_Handler”, “On_Click_Handler” (“Hello World” has been input), and an “Image” (the capital letter B has been chosen. The details may be saved and the user may close all Items that were opened. In some instances, the user may log out of the client application 425 and log back into the client application 425 to view the changes, while in some embodiments the user may refresh the user interface.

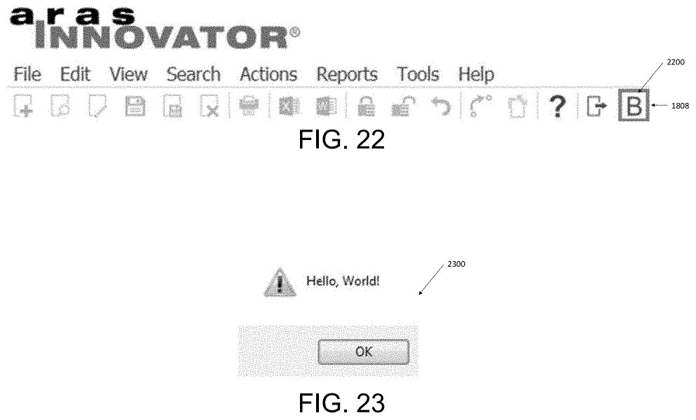

In any instance, a request may be transmitted to the backend 410 to cause the CUI server engine 415 to generate the CUI definition including the metadata for the newly added button at the global level. The CUI definition may be returned to the client application 425 and rendered on the display screen. For example, FIG. 22 illustrates a button 2200 added to the command bar (Main Window Toolbar 1808) according to various embodiments of this disclosure. The sequence of the button 2200 being added to the command bar may be based upon the sort_order specified when creating the button. Upon selection of the button 220, and as depicted in FIG. 23, an alert 2300 may be displayed that says “Hello World”.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A method for configuring a layout of a user interface for a plurality of clients, comprising:
receiving, from a first client, a first message comprising a modification to a user interface element at a location of a section of the user interface, and a property of the user interface element;
modifying, based on the first message, an item within a self-describing data system that defines an overall layout of the user interface, wherein the item represents the user interface element;
receiving, from the first client, a request to view the user interface;
determining metadata that defines a tailored layout of the user interface including the user interface element for the first client using the self-describing data system based on at least the property of the user interface element; and
providing a second message comprising the metadata to the first client to render the tailored layout of the user interface including the user interface element for the first client on a display.

2. The method of claim 1, further comprising:
providing one or more graphical user interface elements on the user interface to enable entry of the modification to the user interface element and the property, and to enable transmittal of the first message.

3. The method of claim 1, further comprising:
receiving, from a second client, a request to view the user interface, wherein the request comprises a second property;
determining second metadata that defines a second tailored layout of the user interface, wherein the second tailored layout:
excludes the user interface element for the second client using the self-describing data system based on at least the property of the user interface element,
includes a second user interface element for the second client that is excluded from the first tailored layout for the first client, or
includes a third user interface element that is common in both the second tailored layout for the second client and the tailored layout for the first client; and
providing a third message comprising the second metadata to the second client to render the second tailored layout of the user interface.

4. The method of claim 1, further comprising:
receiving, from a second client, a third message comprising a second modification to a second user interface element at a second location in the section of the user interface, and a second property of the user interface element;
modifying, based on the third message, a second item within the self-describing data system, wherein the second item represents the second user interface element;
receiving, from the first client, a request to view the user interface;
determining second metadata that defines a tailored layout of the user interface for the first client using the self-describing data system based on at least the property of the user interface element and the second property of the second user interface element; and
providing a fourth message comprising the second metadata to the first client to render the tailored layout of the user interface including the user interface element and the second user interface element on the display.

5. The method of claim 1, wherein:
the property specifies including the user interface element at the location in the section globally,
the property specifies including the user interface element at the location in the section based on an item type of the section,
the property specifies including the user interface element at the location in the section based on an identity of a user associated with a client requesting the user interface, or
the property specifies including the user interface element at the location in the section based on a classification of the item type of the section.

6. The method of claim 1, wherein the first message further comprises an event and an event handler for the user interface element, and the item in the self-describing data system is modified based on the event and the event handler for the user interface element.

7. The method of claim 1, further comprising:
receiving, from the first client, a second request to view the user interface, wherein the second request comprises a second property pertaining to a first item type;
determining second metadata that defines a second tailored layout of the user interface that includes a second user interface element using the self-describing data system based on the second property pertaining to the first item type;
receiving, from a second client, a third request to view the user interface, wherein the third request comprises a third property pertaining to a second item type different than the first item type;
determining third metadata that defines a third tailored layout of the user interface that includes a third user interface element using the self-describing data system based on the third property pertaining to the second item type, wherein the third user interface element is different than the second user interface element;
providing a third message comprising the second metadata to the first client to render the second tailored layout of the user interface; and
providing a fourth message comprising the third metadata to the second client to render the third tailored layout of the user interface.

8. The method of claim 1, wherein the client renders the user interface including the user interface element at the location in the section at runtime based on the metadata in the second message.

9. The method of claim 1, wherein the second message has a format type that is specific to the client.

10. A tangible, non-transitory computer-readable medium storing instructions that, when executed, cause one or more processing devices to:
receive, from a first client, a first message comprising a modification to a user interface element at a location of a section of the user interface, and a property of the user interface element;
modify, based on the first message, an item within a self-describing data system that defines an overall layout of the user interface, wherein the item represents the user interface element;
receive, from the first client, a request to view the user interface;
determine metadata that defines a tailored layout of the user interface including the user interface element for the first client using the self-describing data system based on at least the property of the user interface element; and
provide a second message comprising the metadata to the first client to render the tailored layout of the user interface including the user interface element for the first client on a display.

11. The computer-readable medium of claim 10, wherein the instructions, when executed, cause the one or more processing devices to:
provide one or more graphical user interface elements on the user interface to enable entry of the modification to the user interface element and the property, and to enable transmittal of the first message.

12. The computer-readable medium of claim 10, wherein the instructions, when executed, cause the one or more processing devices to:
receive, from a second client, a request to view the user interface;
determine second metadata that defines a second tailored layout of the user interface, wherein the second tailored layout:
excludes the user interface element for the second client using the self-describing data system based on at least the property of the user interface element,
includes a second user interface element for the second client that is excluded from the first tailored layout for the first client, or
includes a third user interface element that is common in both the second tailored layout for the second client and the tailored layout for the first client; and
provide a third message comprising the second metadata to the second client to render the second tailored layout of the user interface excluding the user interface element for the second client on the display.

13. The computer-readable medium of claim 10, wherein the instructions, when executed, cause the one or more processing devices to:
receive, from a second client, a third message comprising a second modification to a second user interface element at a second location in the section of the user interface, and a second property of the user interface element;
modify, based on the third message, a second item within the self-describing data structure, wherein the second item represents the second user interface element;
receive, from the first client, a request to view the user interface;
determine second metadata that defines a tailored layout of the user interface for the first client using the self-describing data structure based on at least the property of the user interface element and the second property of the second user interface element; and
provide a fourth message comprising the second metadata to the first client to render the tailored layout of the user interface including the user interface element and the second user interface element on the display.

14. The computer-readable medium of claim 10, wherein:
the property specifies including the user interface element at the location in the section globally,
the property specifies including the user interface element at the location in the section based on an item type of the section,
the property specifies including the user interface element at the location in the section based on an identity of a user associated with a client requesting the user interface, or
the property specifies including the user interface element at the location in the section based on a classification of the item type of the section.

15. The computer-readable medium of claim 10, wherein the first message further comprises an event and an event handler for the user interface element, and the item in the self-describing data structure is modified based on the event and the event handler for the user interface element.

16. A system, comprising:
one or more memory devices storing instructions; and
one or more processing devices communicatively coupled to the one or more memory devices, wherein the one or more processing devices execute the instructions to:
receive, from a first client, a first message comprising a modification to a user interface element at a location of a section of the user interface, and a property of the user interface element;
modify, based on the first message, an item within a self-describing data structure that defines an overall layout of the user interface, wherein the item represents the user interface element;
receive, from the first client, a request to view the user interface;
determine metadata that defines a tailored layout of the user interface including the user interface element for the first client using the self-describing data structure based on at least the property of the user interface element; and
provide a second message comprising the metadata to the first client to render the tailored layout of the user interface including the user interface element for the first client on a display.

17. The system of claim 16, wherein the instructions, when executed, cause the one or more processing devices to:
provide one or more graphical user interface elements on the user interface to enable entry of the modification to the user interface element and the property, and to enable transmittal of the first message.

18. The system of claim 16, wherein the instructions, when executed, cause the one or more processing devices to:
receive, from a second client, a request to view the user interface;
determine second metadata that defines a second tailored layout of the user interface, wherein the second tailored layout:
excludes the user interface element for the second client using the self-describing data system based on at least the property of the user interface element,
includes a second user interface element for the second client that is excluded from the first tailored layout for the first client, or
includes a third user interface element that is common in both the second tailored layout for the second client and the tailored layout for the first client; and
provide a third message comprising the second metadata to the second client to render the second tailored layout of the user interface excluding the user interface element for the second client on the display.

19. The system of claim 16, wherein the instructions, when executed, cause the one or more processing devices to:
receive, from a second client, a third message comprising a second modification to a second user interface element at a second location in the section of the user interface, and a second property of the user interface element;
modify, based on the third message, a second item within the self-describing data structure, wherein the second item represents the second user interface element;
receive, from the first client, a request to view the user interface;
determine second metadata that defines a tailored layout of the user interface for the first client using the self-describing data structure based on at least the property of the user interface element and the second property of the second user interface element; and
provide a fourth message comprising the second metadata to the first client to render the tailored layout of the user interface including the user interface element and the second user interface element on the display.

20. The system of claim 16, wherein:
the property specifies including the user interface element at the location in the section globally,
the property specifies including the user interface element at the location in the section based on an item type of the section,
the property specifies including the user interface element at the location in the section based on an identity of a user associated with a client requesting the user interface, or
the property specifies including the user interface element at the location in the section based on a classification of the item type of the section.
